(19) United States
(12) Patent Application Publication
(10) Pub. No.: US 2024/0315508 A1
(43) Pub. Date: Sep. 26, 2024

(54) METHOD FOR OPERATING A SELF-PROPELLED CLEANING DEVICE AND SELF-PROPELLED CLEANING DEVICE

(71) Applicant: Vorwerk & Co. Interholding GmbH, Wuppertal (DE)

(72) Inventor: Markus FRIEDEL, Ansbach (DE)

(21) Appl. No.: 18/612,311

(22) Filed: Mar. 21, 2024

(30) Foreign Application Priority Data
Mar. 24, 2023 (EP) 23 164 031.9

(51) Int. Cl. A47L 9/28

(52) U.S. Cl. CPC A47L 9/2852; A47L 2201/04

(57) ABSTRACT

A method for operating a self-propelled cleaning device is proposed, wherein the cleaning device has a cleaning mode in which it moves autonomously, wherein the cleaning device has a demonstration mode and can be operated either in the demonstration mode or in the cleaning mode, wherein the cleaning device behaves in the demonstration mode in accordance with a presetting.

According to a first aspect, a task to be performed is defined in the presetting, wherein the cleaning device automatically terminates the demonstration mode after completion of the task and returns to its initial position and initial orientation at the beginning of the demonstration mode for termination.

According to a further aspect, a straight path to be traveled by the cleaning device is defined in the presetting.

A cleaning device designed to perform the method is also proposed.

### BACKGROUND

The present invention relates to a method for operating a self-propelled cleaning device and a self-propelled cleaning device.

In the prior art, self-moving or self-propelled cleaning devices are known, in particular as (partially) autonomous vacuuming robots or mopping robots or combined vacuuming and mopping robots for cleaning surfaces such as floors.

It is known to perform a functional test of important components and functions of a self-propelled cleaning device in the laboratory using appropriate test benches. For example, the functionality of sensors and motors, a navigation function, an object detection and/or avoidance or battery charging capability can be examined in detail in such a laboratory. However, the prerequisite for this is that the cleaning device is brought to the laboratory and the corresponding special measuring devices and equipment are available there. Furthermore, very different measuring devices and setups are required to test the various functions and components, so that in some cases several laboratories even have to be run through for a complete test of a cleaning device. Finally, the test environment in the laboratory differs from the environment in later use by the user or customer, especially in their living rooms, so that possible errors do not occur at the user/customer and/or errors are not detected in the laboratory.

It is also known that self-propelled cleaning devices navigate autonomously in cleaning mode and determine the path to be taken to clean the environment. In cleaning mode, the path taken by the cleaning device is therefore random or unpredictable. This entails disadvantages for testing functions and/or demonstrating the cleaning device, for example when a customer advisor demonstrates it to a potential buyer or when a user or owner of the cleaning device demonstrates a (supposed) malfunction of the cleaning device. Such a demonstration or test usually takes place in a store or at the user's or potential buyer's home. During the demonstration, it can easily happen that the cleaning device moves under a table, cabinet or the like, so that a clear view of the cleaning device is blocked and the behavior of the cleaning device cannot be observed. Furthermore, the demonstration or test is not reproducible and no targeted demonstration or testing of functions is possible.

Furthermore, it may be necessary to configure the cleaning device before or first commissioning and/or first use in a new environment, for example by first creating a map of the environment that is used for navigation during cleaning operation. Such a configuration is time-consuming, can lead to problems and makes a (quick) demonstration and/or test of the cleaning device more difficult or impossible.

It is therefore a problem underlying the present invention to provide a solution which enables or facilitates a targeted demonstration and/or targeted testing of functions of a self-propelled cleaning device.

### SUMMARY

The problem underlying the invention is solved by a method or a cleaning device as disclosed herein.

A cleaning device within the meaning of the present invention is preferably a (partially) autonomous or self-propelled vacuum cleaning robot, hereinafter referred to as a vacuuming robot, or a mopping robot or combined vacuuming and mopping robot. However, a cleaning device within the meaning of the present invention may also be another device for cleaning and/or maintaining surfaces, in particular floors. For example, polishing devices or robots, window cleaning devices or robots or lawn mowing devices or robots are also basically to be understood as cleaning devices within the meaning of the present invention.

The method according to the invention relates to the operation of a self-propelled cleaning device. In particular, the method is a computer-implemented method.

The cleaning device has a cleaning mode, in which it moves autonomously, and a demonstration mode, wherein the cleaning device can be operated or is operated either in the demonstration mode or in the cleaning mode.

In the demonstration mode, the cleaning device behaves according to a presetting. This makes the behavior of the cleaning device predictable or reproducible and enables targeted testing and/or demonstration of cleaning device functions.

According to a first aspect of the method, a task to be completed is defined in the presetting, wherein the cleaning device automatically terminates the demonstration mode after completion of the task and returns to its starting position at the beginning of the demonstration mode for termination. Preferably, the cleaning device also returns to its starting orientation at the start of the demonstration mode to terminate the demonstration mode. This facilitates a demonstration and/or testing of functions of the cleaning device, in particular a repetition of the demonstration or test and/or a sequential demonstration and/or testing of different functions one after the other, since the cleaning device is immediately ready for use again after completion of the task and does not first have to be manually moved or rotated to a desired starting position and/or starting orientation.

According to a further aspect, which can also be realized independently, a straight path to be traveled by the cleaning device is defined in the presetting. This makes it particularly easy to specifically test and/or demonstrate the functions of the cleaning device, especially if there is little space available for testing and/or demonstrating.

Preferably, an operating time and/or a length of the path to be traveled is/are defined in the presetting. In this way, a defined behavior is achieved in demonstration mode and/or a defined end of the demonstration mode is ensured.

It is also preferable that the operating time and/or the length of the path to be traveled is/are adjustable. This enables simple adaptation to the functions to be tested and/or to the environment in which a demonstration and/or a test of the cleaning device takes place.

In demonstration mode, the cleaning device preferably detects obstacles. The presetting preferably specifies how the cleaning device reacts to detected obstacles. For example, the presetting can specify that the cleaning device stops and/or turns through a certain angle, for example 90° or 180°, when an obstacle is detected. This enables a defined demonstration or testing of an object detection function or object avoidance function of the cleaning device in demonstration mode and, in particular, the behavior when obstacles are detected can be predicted.

It is particularly preferred that the cleaning device moves along the path defined in the presetting, avoids the detected obstacle when an obstacle is detected, deviates from the path and then returns to the path and/or continues to move in a straight line.

According to a preferred aspect, the cleaning device detects boundaries in demonstration mode and moves along a detected boundary. Such a function is also referred to as “boundary follow”.

Recognizing and avoiding obstacles as well as recognizing and driving along boundaries are among the most important functions of self-propelled cleaning devices, so it is important to be able to test or demonstrate these functions in demonstration mode.

To end the demonstration mode, the cleaning device preferably returns to the starting position, in particular by taking the shortest route and/or by traveling back the way it came from the starting position. This enables an immediate restart of the demonstration mode or other functions of the cleaning device and/or ensures a defined termination of the demonstration mode.

The task defined in the presetting can comprise several subtasks, which the cleaning device completes one after the other in demonstration mode, in particular whereby the cleaning device returns to its starting position and preferably starting orientation at the beginning of the demonstration mode after completing a subtask and then completes the next subtask. In this way, various functions of the cleaning device can be tested and/or demonstrated quickly and/or in a time-saving and/or comprehensive manner.

It is preferred that the cleaning device has an input device arranged on the cleaning device, whereby the demonstration mode can be selected or is selected via the input device. This is conducive to an uncomplicated and direct start of operation in demonstration mode. In particular, there is no need for prior configuration and/or connection to an app to start and/or control the cleaning device or demonstration mode.

After selecting the demonstration mode, the cleaning device preferably begins to move immediately, in particular in a straight line starting from the orientation of the cleaning device when the demonstration mode is selected or started. As a result, the behavior of the cleaning device in demonstration mode is predictable and a demonstration or test can be carried out quickly.

According to a preferred aspect, an area to be covered by the cleaning device, hereinafter also referred to as a demonstration area, of a certain size and/or shape is specified in the presetting. In particular, this simulates the operation of the cleaning device in cleaning mode or comes particularly close to it, so that the demonstration mode enables the behavior in cleaning mode to be tested and/or demonstrated under controlled conditions.

The size and/or shape of the area to be cleaned or the demonstration area is preferably adjustable. This enables adaptation to an environment in which a test and/or demonstration of the cleaning device takes place.

Particularly preferably, the cleaning device has several different selectable demonstration modes, preferably with the different demonstration modes having different defaults. In the different demonstration modes, the cleaning device therefore preferably exhibits different behaviors and/or the cleaning device performs different functions. For example, it may be provided that in one demonstration mode a two-dimensional, for example rectangular or square, area is scanned, while in another demonstration mode a one-dimensional or linear area, in particular a straight path, is scanned. The different demonstration modes enable the demonstration, testing, setting and/or calibration of different functions or behaviors of the cleaning device. It is also possible to select a demonstration mode adapted to the respective situation or environment.

It is preferable that a coupling and/or establishment of a data connection with a network and/or an external device takes place before or during initial operation of the cleaning device. This enables the software or firmware of the cleaning device to be updated and/or the cleaning device to be controlled externally, for example via an app and/or a smartphone. Furthermore, this makes it possible to store a map in a cloud and/or to set special cleaning areas and/or prohibited areas in the map and to name the cleaning areas and/or prohibited areas in the map.

According to a further aspect, before or during initial operation of the cleaning device in cleaning mode, a map of the environment of the cleaning device is created and/or a query is made as to whether a map of the environment of the cleaning device should be created, in particular wherein the cleaning device in cleaning mode automatically determines and/or optimizes a path to be taken during a cleaning process on the basis of the created map. In this way, cleaning processes can be optimized and, for example, certain areas can be excluded from cleaning.

Preferably, the cleaning device does not establish a coupling or data connection with a network and/or an external device in demonstration mode and/or it is provided that the cleaning device can be operated or is operated in demonstration mode without establishing a data connection or coupling with a network and/or external device.

Preferably, the cleaning device does not create a map of a cleaning area in demonstration mode and/or is not queried in demonstration mode as to whether a map of the environment of the cleaning device should be created and/or is operated in demonstration mode without a map of the environment of the cleaning device.

This allows functions to be tested and/or demonstrated quickly and/or easily in demonstration mode, in particular in an environment other than the environment in which the cleaning device is typically used. For example, if a user observes a (supposed) faulty behavior of the cleaning device, this faulty behavior can also be demonstrated in a different environment, for example in a store, in which no data connection can be established with a network to which the cleaning device is coupled and/or in which a previously created map does not match the real environment. Furthermore, the demonstration or testing of the cleaning device in different environments, for example by a customer advisor and/or in different households, is facilitated.

In demonstration mode, one or more functions of the cleaning device can preferably be optionally set, switched on and/or switched off, in particular detection of obstacles and/or boundaries, avoidance of obstacles, driving along boundaries, a type of cleaning or a cleaning performance or its adjustment, and/or a speed or speed adjustment. This enables targeted testing or demonstration of certain functions and/or enables or facilitates troubleshooting.

It is preferred that settings for operation in cleaning mode can be made in demonstration mode, in particular a calibration of one or more sensors, a setting of a type of cleaning and/or a cleaning power, a setting of a drive power, a setting of a drift correction, and/or a setting and/or calibration of a detection of obstacles and/or boundaries and/or a reaction to a detected obstacle and/or a detected boundary. This enables simple or uncomplicated adaptation to the usual environment in which the cleaning device is used, for example adaptation to the household of the user or owner of the cleaning device. Furthermore, behaviors or functions can be adapted to the wishes of a user, for example a speed or cleaning performance of the cleaning device or a sensitivity when detecting and/or avoiding objects such as obstacles or boundaries.

According to a further aspect, which can also be realized independently, the present invention relates to a self-propelled cleaning device comprising a cleaning mode and a demonstration mode, wherein the cleaning device is designed to carry out the method described herein.

According to a further aspect, which may also be realized independently, the present invention relates to a self-propelled cleaning device comprising means adapted to perform the method described herein.

According to a further aspect, which can also be realized independently, the present invention relates to a computer program comprising instructions which, when executed, cause the cleaning device described herein to perform the method described herein.

According to a further aspect, which can also be realized independently, the present invention relates to a computer-readable medium on which the aforementioned computer program is stored.

In particular, the cleaning device, the computer program and the computer-readable medium achieve corresponding advantages of the method.

The aforementioned aspects, features and method steps of the present invention as well as the aspects, features and method steps of the present invention resulting from the claims and the following description can in principle be realized independently of one another, but also in any combination or sequence.

Further aspects, advantages, features and properties of the present invention are apparent from the claims and the following description of preferred embodiments with reference to the drawings.

### BRIEF DESCRIPTION OF THE DRAWINGS

FIG. 1 is a schematic perspective representation of a cleaning device according to the invention;

FIG. 2 is a schematic side view of the cleaning device according to the invention;

FIG. 3 is a schematic representation of an exemplary behavior of the cleaning device in demonstration mode, wherein the cleaning device travels along a straight path;

FIG. 4 is a further schematic representation of an exemplary behavior of the cleaning device in demonstration mode, wherein the cleaning device travels along a straight path while avoiding an obstacle;

FIG. 5 is a further schematic representation of an exemplary behavior of the cleaning device in demonstration mode, wherein the cleaning device travels along a boundary;

FIG. 6 is a further schematic representation of another exemplary behavior of the cleaning device in demonstration mode, wherein the cleaning device travels over a demonstration area;

FIG. 7 is a further schematic representation of an exemplary behavior of the cleaning device in demonstration mode, wherein the cleaning device travels along a demonstration area while avoiding an obstacle; and

FIG. 8 is a schematic representation of the cleaning device, a network and an external device.

### DETAILED DESCRIPTION

In the Figures, the same reference symbols are used for identical or similar parts and components, wherein corresponding or comparable properties or advantages are achieved, even if a repeated description is omitted.

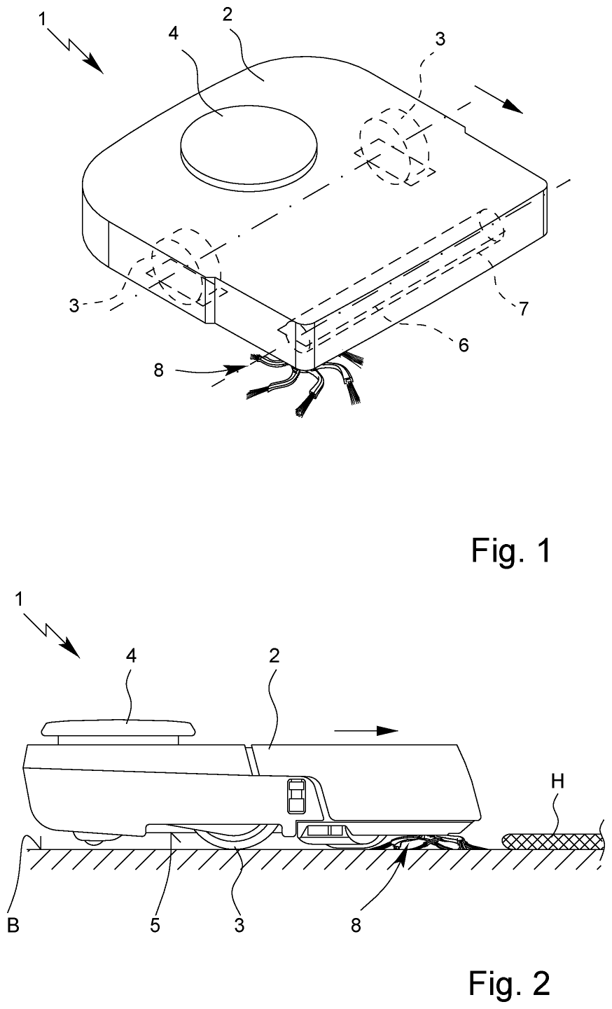

FIGS. 1 and 2 show a self-propelled (mobile) cleaning device 1 in different views.

The cleaning device 1 is preferably designed as a vacuuming robot or is designed to automatically or autonomously travel over a floor B or a cleaning surface formed thereby. In particular, the cleaning device 1 is designed to suck suction material or air together with suction material from the floor B.

Alternatively or additionally, however, the cleaning device 1 can also be designed to mop the floor B or have a floor mopping function. In other words, the cleaning device 1 can also be designed as a floor mopping robot or a combined vacuuming and mopping robot.

In the following description, it is assumed that the floor B is at least essentially flat and horizontal. In particular, the term “horizontal” is used for directions parallel to the floor B and refers in particular to the position of use of the cleaning device 1 shown in the Figures.

The cleaning device 1 has a housing 2 and several, in this case two, electric motor-driven wheels 3 and a navigation device 4.

By means of the navigation device 4 and the wheels 3, the cleaning device 1 can orient itself and move autonomously within an environment and/or on the floor B.

The navigation device 4 preferably has one or more sensors for detecting the environment and/or the floor B and/or for detecting objects, obstacles H and/or boundaries G. The navigation device 4 can have separate sensors at different positions on the cleaning device 1.

In particular, the navigation device 4 has a laser scanner or rotating laser, wherein the laser scanner or laser is designed to scan the environment of the cleaning device 1 and/or to measure distances to objects in the environment of the cleaning device. The laser scanner or laser is used in particular to detect walls and/or boundaries. In particular, the laser scanner or laser is designed as a lidar sensor or has a lidar sensor.

The navigation device 4 preferably has one or more floor sensors for detecting the floor B and/or edges or depressions in the floor. The floor sensor(s) is/are preferably designed as an ultrasonic sensor or infrared sensor.

Preferably, the navigation device 4 has a camera, in particular a time-of-flight camera, as a sensor. The camera is used in particular to detect objects and/or obstacles.

Alternatively or additionally, the navigation device 4 can have further sensors.

On a bottom side 5 or a side 5 facing the floor B, the cleaning device 1 has an aspiration opening 6, in particular an elongated or slit-like opening, through which dirt can be picked up or sucked in from the floor B.

Relative position designations used herein, such as “top”, “bottom”, “top side”, “bottom side” or the like, refer to the position of use of the cleaning device 1 shown in the Figures, in which the cleaning device 1 travels or can travel along the floor B and/or the wheels 3 contact the floor B.

The cleaning device 1 is preferably equipped with an electric motor-driven blower (not shown) and a collection container (not shown) for the vacuumed material.

During cleaning operation of the cleaning device 1, suction material or air together with suction material can be sucked from the floor B into the cleaning device 1, in particular the collection container, via the aspiration opening 6. The cleaning device 1 preferably has the blower to suck in the suction material.

The suction material is preferably separated from the air in the collection container, for example by means of a filter not shown, wherein the (cleaned) air can then be released back into the environment.

Optionally, the cleaning device 1 is equipped with at least one cleaning roller 7, wherein the cleaning roller 7 is arranged in the aspiration opening 6.

The cleaning roller 7 is driven to rotate about an axis of rotation that is at least substantially horizontal in the usual position of use of the cleaning device 1, preferably by means of an electric motor (not shown). Particularly preferably, the axis of rotation of the cleaning roller 7 runs at least substantially parallel to the axis of rotation of the wheels.

Furthermore, the cleaning device 1 optionally has—in particular in addition to or as an alternative to the cleaning roller 7—a sweeping brush 8, wherein the sweeping brush 8 is preferably driven to rotate about an axis of rotation which is at least substantially vertical in the usual position of use of the cleaning device 1, preferably by means of an electric motor (not shown).

The (usual) direction of travel of the cleaning device 1 is shown by an arrow in FIGS. 1 and 2.

The cleaning device 1 is preferably designed to carry out the method described herein for operating the cleaning device 1. Preferably, the cleaning device 1 has means adapted to carry out the method described herein.

In particular, the cleaning device 1 has a control device 9 which is designed, or by which the cleaning device 1 is designed, to carry out the method described herein. Preferably, the control device 9 has the aforementioned means for carrying out the method or the aforementioned means for carrying out the method are formed by the control device 9.

The cleaning device 1, in particular the control device 9, preferably has a computer program which has commands which, when executed, cause the method described herein to be carried out.

The cleaning device 1, in particular the control device 9, preferably has a computer-readable medium on which the aforementioned computer program is stored.

The method according to the invention is explained in more detail below.

The method is used to operate the cleaning device 1.

The cleaning device 1 has a cleaning mode and at least one demonstration mode.

The cleaning mode is understood or referred to in particular as an operating mode of the cleaning device 1 in which the floor B is cleaned or in which the cleaning device 1 is typically operated.

The demonstration mode is understood or referred to in particular as an operating mode of the cleaning device 1 in which a (targeted) demonstration or a (targeted) test of the cleaning device 1 takes place or can take place and/or in which the cleaning device 1 exhibits a defined or predictable behavior.

The cleaning device 1 can have several demonstration modes, which will be discussed in more detail later. Unless otherwise explained or if there are obvious contradictions, if the cleaning device 1 has several demonstration modes, the following explanations regarding the demonstration mode refer to all demonstration modes. Differences between different demonstration modes will be explained separately later.

Furthermore, it is also possible that the cleaning device 1 has different cleaning modes or can perform different cleaning processes in cleaning mode, for example cleaning processes adapted to different floors B.

In the cleaning mode, the cleaning device 1 moves freely and/or autonomously, in particular with the cleaning device 1 navigating independently using the navigation device 4. In particular, the cleaning device 1 cleans a cleaning area in cleaning mode.

In the demonstration mode, the cleaning device 1 moves and/or behaves according to a presetting. In particular, the cleaning device 1 therefore shows a defined, predetermined, predictable and/or reproducible behavior in the demonstration mode. In particular, the cleaning device 1 shows the same behavior each time it is operated in the demonstration mode.

In contrast, the behavior of the cleaning device 1 in the cleaning mode is preferably random and/or self-determined and/or unpredictable. In particular, in the cleaning mode, the cleaning device 1 itself determines how it moves, whereas the behavior in demonstration mode is (to a certain extent) predetermined or follows the presetting.

The demonstration mode is used in particular to run various functions or behaviors of the cleaning device 1 in a targeted manner, in particular for demonstration purposes and/or for test purposes. Furthermore, the demonstration mode is preferably used alternatively or additionally to make settings for the cleaning mode.

In particular, the cleaning device 1 behaves differently in demonstration mode than in cleaning mode.

In the presetting, a task to be performed/completed is preferably defined. In the demonstration mode, the cleaning device 1 performs/completes the task.

The task defined in the presetting and/or to be completed can comprise several subtasks.

For example, the task or a subtask of the task may consist of driving over a demonstration area D, which is in particular defined in the presetting, and/or driving along a predetermined path W or following a predetermined path W.

In particular, the cleaning device 1 travels the same path W and/or the same demonstration area D each time it is operated in the demonstration mode, provided that no demonstration mode settings are changed in the meantime or between two operations.

It is also possible that the task to be completed or a subtask of the task consists of showing or demonstrating or performing a certain behavior, for example avoiding an obstacle H and/or driving along a boundary G and/or performing a certain cleaning process, for example a cleaning process intended or optimized for hard floors such as parquet or tiles or a cleaning process intended or optimized for carpets.

After completing the task, the cleaning device 1 terminates the demonstration mode, preferably automatically. In particular, at the end of the demonstration mode and/or after completion of the task, in particular also after completion of one, several or all subtasks, the cleaning device 1 returns at least substantially to its starting position and/or starting orientation in which it was before or at the start or selection of the demonstration mode. In this way, a “catwalk behavior” is made possible, in which the cleaning device 1 executes different functions or behaviors one after the other and, in particular, returns to the starting position and preferably the starting orientation after each execution. This enables quick and uncomplicated demonstration and/or testing of various functions.

Preferably, the cleaning device 1 determines its starting position and/or starting orientation autonomously, in particular by means of respective position detection sensors and/or the navigation device 4 and/or independently of external devices such as a base station.

The return to the starting position and/or starting orientation preferably takes place at least essentially along the shortest path and/or by the cleaning device 1 returning at least essentially along the path W that it has covered or traveled in the demonstration mode starting from the starting position. In principle, however, the cleaning device 1 can also return to the starting position along a path other than the shortest path or the path traveled from the starting position.

Preferably, a path W to be covered or traveled by the cleaning device 1 and/or a demonstration area D to be traveled is/are defined in the presetting. The path W and/or the demonstration area D is traveled in demonstration mode, in particular in accordance with the presetting.

The path W is in particular a straight path. In principle, however, the path W can also be another path, for example a curved, in particular oval or circular, path, a zigzag path or spiral path or a path that at least essentially describes a geometric or two-dimensional figure, in particular a triangle, a rectangle, a square, a trapezoid, a rhombus or the like.

The path W can be defined explicitly as a path to be traveled or can be defined implicitly, for example by a presetting that defines how the cleaning device reacts to (virtual) boundaries G and/or obstacles H.

The demonstration area D is in particular an area to be covered by the cleaning device 1 in demonstration mode, in particular a surface to be covered. However, the demonstration area D can also—alternatively or additionally—have the predetermined path W or be formed by it.

The demonstration area D is in particular a two-dimensional/laminar area, in particular at least essentially in the form of a circle, an ellipse, a triangle, a square, a rectangle or the like.

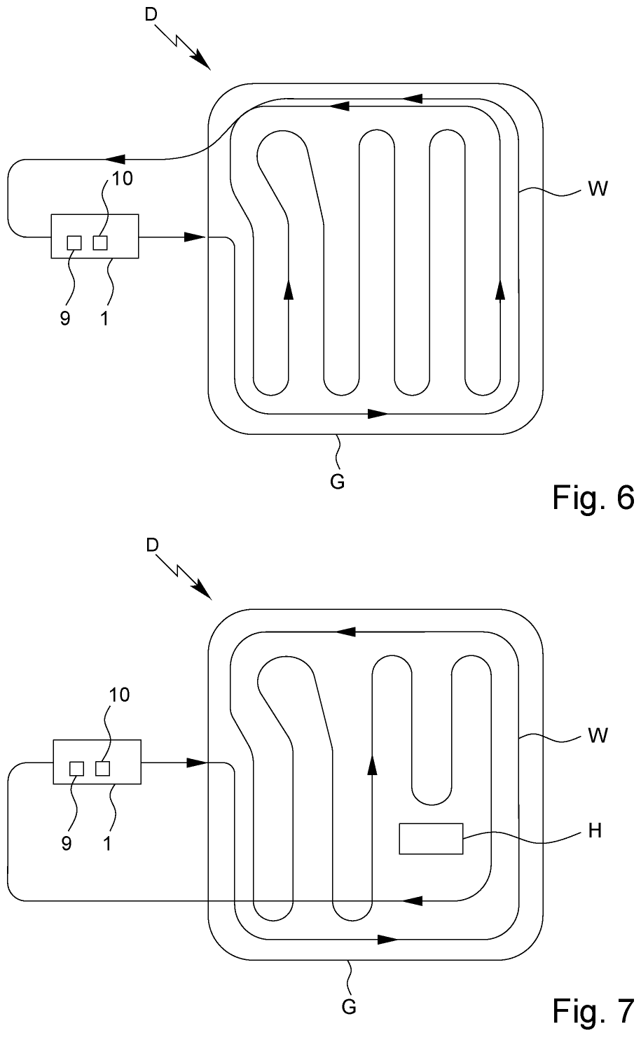

Preferably, it is defined in the presetting how or on which path W the demonstration area D is traveled. In particular, a pattern can be specified according to which the demonstration area D is traveled. For example, the path or pattern can be specified so that the demonstration area D is traveled at least essentially along parallel lines or that an edge area of the demonstration area D is traveled first and then an inner area of the demonstration area D that has not yet been moved is traveled, in particular according to a specified pattern such as in at least essentially parallel lines, as shown, for example, in FIG. 6.

Preferably, the demonstration area D is defined or virtually limited, in particular completely, by virtual boundaries G. The demonstration area D or the virtual boundaries G are preferably completely independent of the real environment of the cleaning device 1. In particular, the demonstration area D is not compared or matched with the real environment of the cleaning device 1.

The path W can be explicitly defined as a path to be traveled or can be implicitly defined, for example by a presetting that defines how the cleaning device 1 reacts to (virtual) boundaries G or obstacles H.

In the cleaning mode, preferably no path W to be travelled by the cleaning device 1 is defined or the path W travelled by the cleaning device 1 is selected, in particular optimized, automatically and/or by the cleaning device 1 itself. In this sense, there is in particular no presetting of a path W to be traveled in the cleaning mode.

Preferably, in the cleaning mode, no area to be traveled by the cleaning device 1 is defined and/or the cleaning area is only partially limited, in particular by virtual boundaries G. For example, certain areas may be declared as prohibited zones (also referred to as “no-go areas”) on a map, which the cleaning device 1 is not allowed to enter. In this sense, there is preferably no presetting of an area to be driven over in cleaning mode.

Preferably, the cleaning device 1 has several demonstration modes, which in particular can be selected as required. The demonstration modes preferably have different presettings for the behavior of the cleaning device 1 in the respective demonstration mode.

In particular, in one of the demonstration modes, the driving along a straight path W can be defined in the presetting as the task or subtask to be completed, and in another of the demonstration modes, the traveling over a preferably rectangular, in particular square, demonstration area D can be defined in the presetting as the task to be completed or as part of a task to be completed.

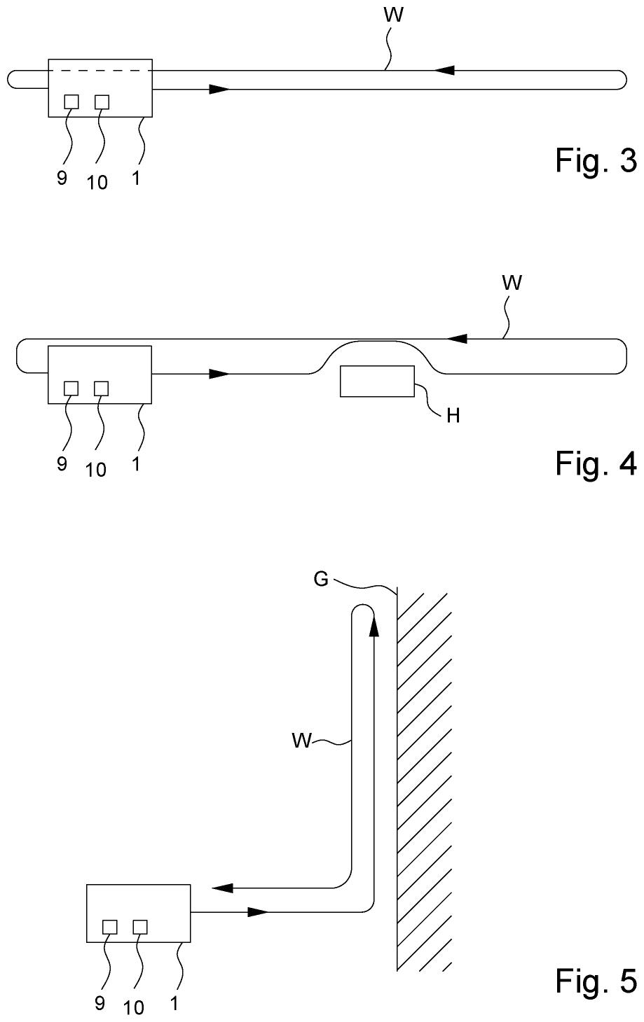

FIGS. 3 to 7 show examples of different demonstration modes.

FIGS. 3 to 5 show a first demonstration mode and FIGS. 6 and 7 show a second demonstration mode which is different from the first demonstration mode or has a different presetting than the first demonstration mode.

In the presetting of the first demonstration mode shown in FIGS. 3 to 5, a straight path W to be traveled by the cleaning device 1 is defined in the presetting.

In particular, in the examples shown in FIGS. 3 and 5, the cleaning device 1 returns to the starting position on the same path that it traveled from the starting position. For better visualization, however, the outward path from the starting position and the return path to the starting position are shown slightly offset from each other in FIGS. 3 and 5.

The first demonstration mode is particularly suitable for testing and/or demonstrating directional stability, a navigation function or functionality of the navigation device 4, a function of the engine and transmission and/or a suction power of the cleaning device 1.

In the presetting of the second demonstration mode shown in FIGS. 6 and 7, an essentially rectangular or square demonstration area D to be covered by the cleaning device 1 is defined in the presetting. Preferably, the path W along which the cleaning device 1 travels or should travel along the demonstration area D is also defined.

In the presetting of the demonstration mode, the length of the path W to be traveled and/or the size and/or shape of the demonstration area D to be traveled is preferably defined.

The second demonstration mode is particularly suitable for testing and/or demonstrating a navigation function or the functionality of the navigation device 4, a cleaning function, an object detection and/or object avoidance function, and/or a function of various sensors of the cleaning device 1.

The following explanations again refer generally to the demonstration mode or to various or several demonstration modes.

The length of the path W is preferably at least 1 m and/or at most 10 m. For example, the length of the path W can be 2 m or 4 m. Preferably, the length of the path W is adjustable or changeable and/or paths W of different lengths are preset in different demonstration modes.

It is possible that the return to the starting position is part of the predetermined path W or that the starting position and an end position of the path W are identical. Alternatively, however, it is also possible that a path from the starting position to an end position different from the starting position is specified as the path W and the cleaning device 1 automatically returns to the starting position after reaching the end position or traveling the path W.

The size of the demonstration area D is preferably at least 1 m² and/or at most 10 m². For example, the size of the demonstration area D can be 1 m×1 m, 1 m×2 m or 2 m×2 m or the demonstration area D can be formed by a circular area with a radius of 0.5 m or 1 m. Preferably, the size and/or shape of the demonstration area D is adjustable or changeable and/or demonstration areas D of different sizes and/or shapes are preset in different demonstration modes.

Alternatively or additionally, an operating duration for operation in the demonstration mode can be defined in the presetting. The operating duration is preferably at least 20 seconds and/or at most 2 minutes. However, longer and shorter operating durations are also possible. Preferably, the operating duration is adjustable or changeable and/or different operating durations are preset in different demonstration modes.

Preferably, the cleaning device 1 recognizes objects in the demonstration mode, in particular obstacles H and/or boundaries G. In the demonstration mode, the cleaning device 1 preferably avoids recognized obstacles H and/or preferably drives along recognized boundaries G.

An obstacle His preferably an object that the cleaning device 1 must avoid or that the cleaning device 1 cannot pass over. In particular, an obstacle H can be formed by an object rising or extending upwards from the floor B, for example a carpet, a wall or a piece of furniture (e.g. a chair, table, cupboard, bed or the like) or a part thereof. However, an obstacle H can also be formed by relatively small objects, in particular objects with an extension of only a few millimeters or centimeters, for example children's toys or parts thereof, in particular Duplo or Lego bricks. An obstacle H is preferably a real object, but can also be formed by a virtual object, in particular a virtual area, which is marked as obstacle H in a map or is treated as obstacle H by the cleaning device 1.

A boundary G is preferably an in particular rectilinear and/or elongated object, at which the cleaning device 1 changes or must change its direction of travel and/or along which the cleaning device 1 can travel. A boundary G can be a virtual or a real object. A virtual boundary G can, for example, be entered in a map of the cleaning device 1 and/or be formed by a laser beam or a magnetic strip and/or be defined in the presetting of the demonstration mode. In particular, the edge of the demonstration area D represents a virtual boundary G. A real boundary G can be formed, for example, by a wall and/or step extending upwards from floor B, a door, an extended piece of furniture, in particular a baseboard or a skirting board of a piece of furniture, and/or an edge of a recess in the floor B.

In particular, a boundary G may have or form an obstacle H and an obstacle H may have or form a boundary G.

The presetting preferably defines how the cleaning device 1 reacts to a detected boundary G or a detected obstacle H. In other words, the presetting preferably contains instructions or predefined behaviors in which a reaction to certain events, in particular the detection of an obstacle H and/or a boundary G, is specified. In particular, deviating from the path W and/or leaving the demonstration area D can be enabled or permitted or defined.

In this sense, a behavior of the cleaning device 1, in which the predefined path W and/or demonstration area D is generally traveled, but in which the path W and/or demonstration area is left when certain events occur, in particular when an obstacle H and/or a boundary G is detected, also represents a travelling of the path W and/or demonstration area D in accordance with the presetting.

The reaction to a detected boundary G or a detected obstacle His preferably the same in demonstration mode as in cleaning mode.

In the presetting, for example, a distance may be defined or definable up to which the cleaning device 1 approaches the obstacle H or the boundary G, or a minimum distance to be maintained from the obstacle H or the boundary G may be defined or definable. Furthermore, it may be defined or definable in the presetting whether and in what way the cleaning device 1 changes its direction of travel and/or travel speed when a boundary G or an obstacle H is detected, for example by defining a rotation by a defined angle and/or in a defined direction and/or by defining a reduction of the travel speed by a specified amount or to a specified travel speed.

Preferably, it is defined in the presetting, in particular in addition to the definition of a path W and/or demonstration area D, that the cleaning device 1 recognizes obstacles H and/or boundaries G and avoids them and/or moves along them—in particular despite the presetting or definition of the path W or demonstration area D. In particular, the cleaning device 1 can leave the defined path W or demonstration area D.

When the cleaning device 1 detects an obstacle H, it preferably avoids it, in particular wherein, if necessary, it leaves the path W and/or demonstration area D defined in the presetting and then preferably returns to the path W or to the demonstration area D or continues to move in accordance with the presetting. In particular, the cleaning device 1 continues its previous movement after avoiding the obstacle H. For example, if the cleaning device 1 has moved in a straight line or along a straight line before the obstacle H, it continues to move in a straight line after avoiding it.

This is shown in more detail in FIGS. 3 to 7.

FIGS. 3 to 5 show a demonstration mode in which travelling along a straight path W, in particular of a specific length, is defined in the presetting.

In FIG. 3, there is no obstacle H along the preset path W. The cleaning device 1 therefore moves in a straight line from the starting position shown and returns to its starting position once it has traveled the specified path W. Preferably, the cleaning device 1 also rotates back to its starting position when it reaches the starting position.

In FIG. 4, there is an obstacle H along the preset path W. The cleaning device 1 recognizes the obstacle H and avoids it. When avoiding the obstacle, the cleaning device 1 leaves the preset path W shown in FIG. 3, which it would follow without obstacle H. After avoiding the obstacle, the cleaning device 1 continues to move in a straight line or along the preset path W. In particular, in the example shown in FIG. 4, the cleaning device 1 returns to the path W that it would follow without the obstacle H (as shown in particular in FIG. 3) after avoiding the obstacle H. However, this is not mandatory. It is also possible that the cleaning device 1 avoids the obstacle H in such a way that the cleaning device 1 continues to move in a straight line after avoiding it, but parallel to the path W shown in FIG. 3.

In FIG. 5, there is a boundary G along the preset path W. The cleaning device 1 detects the boundary G and moves along it. In doing so, the cleaning device 1 leaves the predetermined path W shown in FIG. 3, which it would follow without the boundary G. After reaching an end position, the cleaning device 1 moves back to the starting position and preferably its initial orientation, in the example shown in particular along the same path that it traveled from the starting position to the end position. The end position can be determined, for example, by the fact that the cleaning device has traveled a preset distance at the end position and/or has been operated for a preset operating time.

FIGS. 6 and 7 show a demonstration mode, in which the travelling over a demonstration area D (essentially square in the example shown) is defined in the presetting.

In FIG. 6, there is no obstacle H in the demonstration area D. Thus, starting from the illustrated starting position, the cleaning device 1 travels completely over the demonstration area D, in particular according to a preset pattern or along a preset path, and returns to its starting position after travelling over the demonstration area D. Preferably, the cleaning device 1 also rotates back to its starting position when it reaches the starting position.

In FIG. 7, there is an obstacle H in the demonstration area D. The cleaning device 1 therefore initially follows the same path W as shown in FIG. 6 until it encounters or recognizes the obstacle H. The cleaning device 1 recognizes the obstacle H and avoids it, in the example shown by reversing its direction of travel. The cleaning device 1 then continues to travel over the demonstration area D, in particular according to the movement pattern before the obstacle H was detected. After travelling over the demonstration area D, the cleaning device 1 returns to its starting position and preferably its starting orientation.

The cleaning device 1 preferably has an input device 10 arranged on the cleaning device 1 or its housing 2. In particular, the input device 10 has one or more buttons and/or knobs and/or a touch-sensitive display (touch display).

Preferably, settings of the cleaning device 1 can be made and/or various operating modes can be selected via the input device 10. In particular, the demonstration mode or one of the demonstration modes can be selected via the input device 10.

It is particularly preferable to use the input device 10 to select the demonstration mode or to start operation in the demonstration mode, in particular by pressing a specific key or key combination. Different demonstration modes can be selectable or selected by pressing different keys or key combinations.

According to another preferred aspect, the demonstration mode can be selected by remote access and/or via an external device 12. This will be explained in more detail later.

Preferably, it is displayed with the input device 10 that the demonstration mode has been selected or which demonstration mode has been selected.

After selecting the demonstration mode, the cleaning device 1 preferably begins to move immediately, in particular in a straight line and/or according to the presetting.

“Immediately” means in particular that no further steps such as configuration or the like take place after the demonstration mode has been selected and before the movement begins. Nevertheless, there may be a (short) time interval between the selection of the demonstration mode and the start of the movement, for example a few seconds. This also represents an immediate start of the movement within the meaning of the present invention.

Operation of the cleaning device 1 in the demonstration mode is preferably possible from any starting position. In particular, no base station is required to operate the cleaning device 1 in the demonstration mode and/or the cleaning device 1 can be operated in the demonstration mode without a base station.

A base station is in particular a station via which the cleaning device 1 or a battery of the cleaning device 1 for providing energy for one or more electric motors for operating the cleaning device 1, in particular for driving the wheels 3, the cleaning roller 7, the sweeping brush 8 and/or a blower for sucking in dirt, is charged or can be charged. A base station is therefore in particular a charging station of the cleaning device 1. Alternatively or additionally, the base station can also be a suction station for sucking dirt out of the cleaning device 1 or its collection container.

In the demonstration mode, one or more functions of the cleaning device 1 can preferably be set, switched on and/or switched off. This is particularly useful for targeted testing and/or demonstrating certain functions and/or for analyzing errors or malfunctions of the cleaning device 1.

In particular, in the demonstration mode, the function that obstacles H and/or boundaries G are detected can be switched on and/or off and/or adjusted as desired. For example, the sensitivity with which obstacles H and/or boundaries G are detected can be set, for example by setting the size and/or dimensions from which an object is classified as a detected obstacle H and/or detected boundary G. For example, it is possible to enable flat objects such as door thresholds, carpets or uneven floors B to be detected or classified as an obstacle H and/or boundary G when a minimum height is reached or exceeded and/or not to be detected or classified as an obstacle H and/or boundary G when a certain height is reached or not reached, for example to allow or prevent the cleaning device 1 from driving over them.

Furthermore, in the demonstration mode, the function that obstacles H are avoided can preferably be switched on and/or off and/or adjusted. For example, it can be adjustable which minimum distance to an obstacle H is maintained and/or in which way a reaction is made to a detected obstacle H, for example a direction in which the cleaning device 1 avoids a detected obstacle H and/or to what extent the speed of movement of the cleaning device 1 is reduced when an obstacle H is detected.

The function of moving along detected boundaries G can preferably be switched on and/or off and/or adjusted in the demonstration mode. For example, the distance and/or direction at which the cleaning device 1 moves along a detected boundary G and/or the maximum time for which the cleaning device 1 moves along a boundary G or the maximum distance covered by the cleaning device 1 when moving along a boundary G may be adjustable.

In the demonstration mode, a cleaning function and/or cleaning power of the cleaning device 1 can be adjusted, switched on and/or switched off. For example, cleaning can be switched off completely in the demonstration mode so that the cleaning device 1 moves in the demonstration mode without performing any cleaning. The type of cleaning can also be adjustable. For example, it can be adjusted whether edge cleaning and/or surface cleaning should be performed, whether the cleaning roller 7 and/or the sweeping brush 8 should be used for cleaning, whether cleaning specifically adapted to a floor covering (e.g. hard floor, tiles, parquet, laminate, PVC, vinyl, carpet, low-pile carpet or high-pile carpet) should be performed and/or whether automatic detection of the floor covering and/or adaptation to the floor covering should be performed. A cleaning power may also be adjustable or adjusted, for example by a suction force and/or a rotational speed of the cleaning roller 7 and/or the sweeping brush 8 being adjustable or adjusted and/or by it being adjustable or adjusted how often a certain floor area is passed over for cleaning. It is also possible to switch on or off an automatic adjustment of the cleaning power and/or the type of cleaning in the demonstration mode, in particular on the basis of a detection of dirt, in the demonstration mode.

Furthermore, a speed at which the cleaning device 1 moves in the demonstration mode can also be set in the demonstration mode and/or the function that the speed of the cleaning device 1 is automatically adjusted, for example when an obstacle H and/or a boundary G is detected and/or depending on a detected floor covering, can be adjusted, switched on and/or switched off.

In the demonstration mode, a position detection function of the cleaning device 1, in particular a position detection function of the navigation device 4 or its sensor/sensors, can also be adjusted, switched on and/or off.

According to a preferred aspect, settings for operation in the cleaning mode can be made or are made in the demonstration mode. In this respect, there is in particular an interaction between the demonstration mode and the cleaning mode: In this sense, the demonstration mode and the cleaning mode are preferably not two completely separate operating modes of the cleaning device 1, but settings can be made in the demonstration mode, which are stored, in particular as settings for operation in the cleaning mode, and have an effect on the behavior of the cleaning device 1 during operation in the cleaning mode.

In particular, a calibration of one or more sensors of the cleaning device 1 and/or the navigation device 4 can be carried out in the demonstration mode. For example, the cleaning device 1 and/or the navigation device 4 can have one or more laser sensors, laser scanners, time-of-flight sensors, cameras, infrared sensors and/or ultrasonic sensors as sensors/sensors. Sensors of the cleaning device 1 can be designed or used, for example, for position detection, object detection, dirt detection and/or detection of a floor covering.

For example, an adjustment or calibration of the navigation device 4 or its sensor/sensors, a floor sensor, which is used in particular to detect edges or depressions in the floor B, and/or a distance meter, which is preferably aligned in the direction of travel of the cleaning device 1 and/or is designed in particular to detect objects located in front of the cleaning device 1 in the direction of travel, can be carried out in demonstration mode. The distance meter can be designed in particular as a laser distance meter, lidar sensor or time-of-flight camera.

Preferably, a drift correction can be carried out in the demonstration mode. In particular, a straight path W to be traveled by the cleaning device 1 is defined in the presetting to this end. If the cleaning device 1 deviates from the defined path W, a corresponding calibration or correction can be carried out, in particular automatically and/or by detecting using sensors that the cleaning device 1 is not moving in a straight line and/or not moving along the defined path W.

Furthermore, the above explanations on the adjustability and/or the ability to switch on and/or switch off of functions in the demonstration mode in particular also apply analogously to settings made in the demonstration mode for operation in the cleaning mode: the aforementioned settings can therefore also be saved in particular for operation in the cleaning mode, so that the cleaning device 1 behaves in the cleaning mode in accordance with the settings or calibrations made in the demonstration mode.

In this way, settings for the function of recognizing obstacles H and/or boundaries G, for the function of avoiding obstacles H, for the function of moving along boundaries G, for the cleaning function and/or cleaning power and/or type of cleaning, for the speed or speed adjustment, and/or for a position detection function can be made in the demonstration mode for operation in the cleaning mode.

Before or during a first/initial operation and/or after the cleaning device 1 is switched on for the first time, the cleaning device 1 is preferably coupled with a network 11 and/or with an external device 12 and/or a data connection V of the cleaning device 1 is established with the network 11 and/or the external device 12.

Preferably, a data connection V can also be established between the external device 12 and the network 11 or a data connection V also exists between the external device 12 and the network 11.

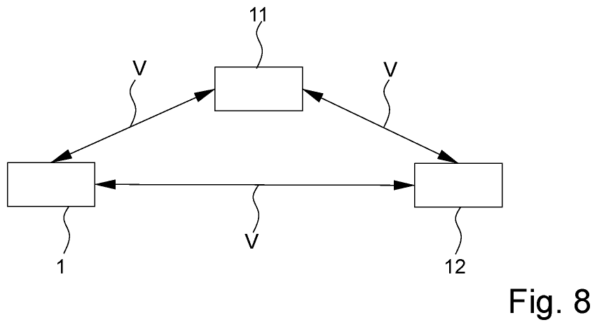

FIG. 8 schematically shows the cleaning device 1, the network 11 and the external device 12 as well as the existing or possible data connections V between them.

The network 11 is preferably a WLAN, mobile network and/or the Internet.

The external device 12 is preferably a base station of the cleaning device 1, a remote control of the cleaning device 1 and/or an app and/or a smartphone, a hotspot or access point or wireless access point, the hotspot or access point or wireless access point in particular being formed by a smartphone and/or being mobile, and/or a server or a cloud.

Preferably, the cleaning device 1 is connected or can be connected indirectly to the external device 12 via the network 11. However, it is also possible that a (direct) data connection V exists or is established between the cleaning device 1 and the external device 12. The direct data connection V between the cleaning device 1 and the external device 12 can in particular be a Bluetooth connection.

Coupling or establishing a data connection V makes it possible in particular to make settings and/or control the cleaning device 1 via the network 11 or the external device 12. Coupling or establishing the data connection V makes it possible in particular to exchange data between the cleaning device 1 and the network 11 or external device 12. For example, software updates or firmware updates of the cleaning device 1 can be carried out, cleaning schedules can be created, rest periods or operating prohibitions of the cleaning device 1 can be defined, areas to be cleaned can be defined and/or configured and/or a charging behavior can be set or controlled. Furthermore, data can be transmitted by the cleaning device 1, for example error or warning messages, messages regarding upcoming and/or completed cleaning and/or charging processes and/or messages regarding necessary maintenance or repair work.

Preferably, an update of a software, in particular control software, and/or firmware of the cleaning device 1 is carried out before or during first/initial operation or after the cleaning device 1 is switched on for the first time. It may be provided that the update is mandatory for operation of the cleaning device 1 or that operation of the cleaning device 1 in the cleaning mode is not possible without an update. The data required for the update are preferably obtained via the data connection V and/or the network 11, in particular via a (mobile) hotspot or access point or wireless access point.

In the cleaning mode, the cleaning device 1 preferably establishes a data connection V with the network 11 and/or the external device 12.

A map of the environment of the cleaning device 1 is preferably created in or for the cleaning mode. Preferably, the map is created before or during a first/initial operation in the cleaning mode and/or a query is made before or during the first/initial operation in the cleaning mode as to whether the map should be created. The query can be made, for example, via a display of the cleaning device and/or via the external device 12, in particular via a corresponding notification, message or query or a corresponding menu in an app for operating or controlling the cleaning device 1.

To create the map, a mapping run is preferably carried out, during which the cleaning device 1 travels its environment or the floor B and creates the map. This is preferably a separate process or a separate run that takes place before the first cleaning process in the cleaning mode. However it can also be provided that a rejection of the (separate) mapping run Is possible and/or that a creation of the map to is carried out during the first cleaning process in the cleaning mode.

The map created is preferably transmitted from the cleaning device to or via the network 11 and/or to the external device 12, in particular a smartphone or a server or a cloud, and stored there. This is done in particular via corresponding data connections V between the cleaning device 1, the network 11 and/or the external device 12.

It may be provided that the creation of a map is mandatory or that operation of the cleaning device 1 is not possible if no map has been created or no map is available.

Preferably, the (previously created) map is transferred from the external device 12 and/or from or via the network 11 to the cleaning device 1 via the data connection V when the cleaning mode is started.

In the cleaning mode, the cleaning device 1 preferably navigates using or taking into account the map. In particular, it may be provided that the cleaning device 1 in the cleaning mode automatically determines and/or optimizes a path W to be taken during a cleaning process on the basis of the map created.

In the map, areas may be defined that the cleaning device 1 should not or must not enter. This can be done, for example, by recognizing obstacles H and/or boundaries G when the map is created and entering these accordingly in the map. Alternatively or additionally, certain areas can also be marked as obstacles H and/or boundaries G in the map, in particular subsequently after the map has been created, so that these areas represent a virtual obstacle H or a virtual boundary G.

At the start or before the start of a cleaning process in the cleaning mode, the cleaning device 1 is preferably located in or on a base station assigned to the cleaning device 1.

After completing a cleaning process in the cleaning mode, the cleaning device 1 preferably moves back to the base station.

Preferably—in particular apart from the aforementioned update when the cleaning device 1 is first put into operation—a data connection V with a network 11, in particular WLAN, mobile network and/or Internet, and/or external device 12, in particular a base station and/or a smartphone and/or an app, is not required for operation in the demonstration mode and/or no such data connection V is established during operation in the demonstration mode.

After the update has been carried out, it is preferably possible to operate the cleaning device 1 in the demonstration mode without any further configuration and/or without coupling with a network 11 and/or external device 12 taking place or being present and/or without a data connection V with a network 11 and/or external device 12 existing or being established. In particular, the cleaning device 1 is operated in the demonstration mode without coupling or establishing a data connection V even if a coupling is carried out or a data connection V is established in the cleaning mode.

According to a preferred aspect, however, the demonstration mode is selected and/or started via the external device 12, in particular a smartphone. In particular, a data connection V to the external device 12 is established for this purpose, in particular via a WLAN and/or a hotspot or access point or wireless access point, which is formed or generated in particular by the external device 12 or smartphone. The demonstration mode can then be selected and/or started via the smartphone or via an app on the smartphone that is used or designed to control or operate the cleaning device 1.

Preferably, no map of the environment of the cleaning device 1 is created during first/initial operation of the cleaning device 1 in the demonstration mode and/or no query is made in the demonstration mode as to whether a map of the environment of the cleaning device 1 should be created and/or operation of the cleaning device 1 is also possible without a map of the environment. In particular, the cleaning device 1 is operated in the demonstration mode without a map even if a map is created in the cleaning mode (during initial operation).

Individual aspects, features and method steps of the present invention can be realized independently of one another, but also in any combination or sequence.

### LIST OF REFERENCE SYMBOLS

1 Cleaning device
2 Housing
3 Wheels
4 Navigation device
5 Bottom side
6 Aspiration opening
7 Cleaning roller
8 Sweeping brush
9 Control device
10 Input device
11 Network
12 External device
B Floor
D Demonstration area
G Boundary
H Obstacle
V Data connection
W Path

1-15. (canceled)

16. A method for operating a self-propelled cleaning device,
wherein the cleaning device has a cleaning mode in which it moves autonomously,
wherein the cleaning device has a demonstration mode and can be operated either in the demonstration mode or in the cleaning mode,
wherein the cleaning device behaves in the demonstration mode in accordance with a presetting, and
wherein a task to be completed is defined in the presetting, wherein the cleaning device automatically terminates the demonstration mode after completion of the task and returns to its starting position at the beginning of the demonstration mode for termination.

17. The method according to claim 16, wherein the cleaning device returns to its starting orientation at the beginning of the demonstration mode for termination of the demonstration mode.

18. The method according to claim 16, wherein a straight path to be traveled by the cleaning device is defined in the presetting.

19. The method according to claim 18, wherein an operating time and/or a length of the path to be traveled is/are defined in the presetting and/or wherein the operating time and/or the length of the path to be traveled is/are adjustable.

20. The method according to claim 16, wherein the cleaning device recognizes obstacles in the demonstration mode.

21. The method according to claim 20, wherein the cleaning device moves along the path defined in the presetting, when an obstacle is detected, avoids the detected obstacle and deviates from the path and then returns to the path and/or continues to move in a straight line.

22. The method according to claim 16, wherein, in the demonstration mode, the cleaning device recognizes boundaries and travels along a recognized boundary.

23. The method according to claim 16, wherein the cleaning device returns to the starting position by the shortest path to terminate the demonstration mode and/or returns to the starting position by traveling back the path traveled from the starting position.

24. The method according to claim 16, wherein the task defined in the presetting comprises a plurality of subtasks which the cleaning device completes successively in the demonstration mode, wherein the cleaning device returns to its starting position at the beginning of the demonstration mode after completion of a subtask and then completes the next subtask.

25. The method according to claim 16, wherein the cleaning device has an input device arranged at the cleaning device, wherein the demonstration mode is selected via the input device.

26. The method according to claim 16, wherein an area of a certain size and/or shape to be traveled over by the cleaning device is predetermined in the presetting.

27. The method according to claim 16, wherein the cleaning device comprises several different selectable demonstration modes.

28. The method according to claim 16, wherein at least one of
(i) before or during a first operation of the cleaning device in the cleaning mode, a map of the environment of the cleaning device is created and/or a query is made as to whether a map of the environment of the cleaning device is to be created, and
(ii) the cleaning device does not create a map of its environment in demonstration mode and/or is not queried as to whether a map of the environment of the cleaning device is to be created and/or operation in demonstration mode takes place without a map of the environment of the cleaning device.

29. The method according to claim 16, wherein the cleaning device does not establish a data connection with a network and/or an external device in demonstration mode and/or can be operated without establishing a data connection or coupling with a network and/or external device.

30. The method according to claim 16, wherein in the demonstration mode one or more functions of the cleaning device can be optionally set, switched on and/or switched off.

31. A method for operating a self-propelled cleaning device,
wherein the cleaning device has a cleaning mode in which it moves autonomously,
wherein the cleaning device has a demonstration mode and can be operated either in the demonstration mode or in the cleaning mode,
wherein the cleaning device behaves in the demonstration mode in accordance with a presetting, and
wherein a straight path to be traveled by the cleaning device is defined in the presetting.

32. The method according to claim 31, wherein an operating time and/or a length of the path to be traveled is/are defined in the presetting and/or wherein the operating time and/or the length of the path to be traveled is/are adjustable.

33. The method according to claim 31, wherein the cleaning device recognizes obstacles in the demonstration mode, wherein the cleaning device moves along the path defined in the presetting, when an obstacle is detected, avoids the detected obstacle and deviates from the path and then returns to the path and/or continues to move in a straight line.

34. The method according to claim 31, wherein, in the demonstration mode, the cleaning device recognizes boundaries and travels along a recognized boundary.

35. A self-propelled cleaning device having a cleaning mode in which it moves autonomously and a demonstration mode, in which it behaves in accordance with a presetting, wherein the cleaning device can be operated either in the demonstration mode or in the cleaning mode, wherein the cleaning device is adapted to perform a method for operating the self-propelled cleaning device, wherein the cleaning device has a cleaning mode in which it moves autonomously, and
a) wherein a task to be completed is defined in the presetting, wherein the cleaning device automatically terminates the demonstration mode after completion of the task and returns to its starting position at the beginning of the demonstration mode for termination, and/or
b) wherein a straight path to be traveled by the cleaning device is defined in the presetting.
